(19) United States
(12) Patent Application Publication
(10) Pub. No.: US 2012/0213099 A1
(43) Pub. Date: Aug. 23, 2012

(54) METHOD AND SYSTEM FOR DYNAMICALLY ADAPTING A MODULATION AND CODING SCHEME

(75) Inventors: Ray-Guang Cheng, Keelung City (TW); Wen-Yen Cheng, New Taipei City (TW)

(73) Assignee: National Taiwan University of Science and Technology, Taipei (TW)

(21) Appl. No.: 13/093,837

(22) Filed: Apr. 25, 2011

(30) Foreign Application Priority Data
Feb. 17, 2011 (TW) 100105269

(51) Int. Cl. H04W 4/06; H04W 24/00

(52) U.S. Cl. 370/252; 370/312; 370/241

(57) ABSTRACT

The invention is directed to a method for dynamically adapting a modulation and coding scheme for a base station transmitting a multicast-and-broadcast service to a plurality of subscribers. The method comprises periodically performing a transmission adapting process. The transmission adapting process comprises steps of setting a feedback condition according to a coverage corresponding to the multicast-and-broadcast service and sending a negative-acknowledge-based feedback query including the feedback condition, a feedback channel and feedback information corresponding to the multicast-and-broadcast service to the subscribers. According to a feedback-receiving status, the base station adapts a modulation and coding scheme for transmitting the multicast-and-broadcast service.

### CROSS-REFERENCE TO RELATED APPLICATION

This application claims the priority benefit of Taiwan application serial no. 100105269, filed Feb. 17, 2011. The entirety of the above-mentioned patent application is hereby incorporated by reference herein and made a part of this specification.

### BACKGROUND OF THE INVENTION

1. Field of Invention

The present invention relates to a method and a system for dynamically adapting a modulation and coding scheme. More particularly, the present invention relates to a method and a system for dynamically adapting a modulation and coding scheme according to a feedback condition corresponding to coverage of a base station.

2. Description of Related Art

The multicast-and-broadcast service (MBS) is one of the important services in the fourth generation (4G) mobile communication system. Under the long term evolution (LTE) of the third generation partnership project (3GPP), the multimedia broadcast/multicast services (MBMS), as know as the multicast-and-broadcast service, provides the multimedia broadcast with a relatively high transmission rate. The conventional communication technology uses the point-to-point (p-t-p) transmission in which the base station (BS) transmits data packets to the destined mobile stations (MS) through the dedicated channel. The multicast-and-broadcast service uses the point-to-multipoint (p-t-m) transmission in which the base station utilizes the same modulation and coding scheme (MCS) to transmit the multicast-and-broadcast service to all of the subscribed mobile stations at the same time through the common multicast-and-broadcast channel. Comparing with the p-t-p transmission, the p-t-m transmission has relatively high spectral efficiency and is more adequate for the condition that the number of mobile stations is large because the p-t-p transmission is implemented with a single channel.

In the multicast-and-broadcast service, the modulation and coding scheme can be adapted with the use of the adequate feedback mechanism to improve the spectral efficiency. With the differences in the feedback mechanism, the capability for improving the spectral efficiency varies. In order to have mobile stations satisfy the service quality, the base station uses the modulation and coding scheme which is suitable for all of the mobile stations to transmit the service to ensure the receiving condition each of the mobile stations. Although the coverage is ensured to be approximate to 100%, the improvement of the spectral efficiency is limited by some of the mobile stations with relatively poor channel quality. Thus, sacrificing the transmission rate of the mobile stations with relatively better channel environment means sacrificing the spectral efficiency. Moreover, different service types and the services with different service fees have different coverage target value. That is, some of the services do not require 100% coverage. Hence, how to improve the spectral efficiency according to the coverage provided by the service providers, the number of the mobile stations in the unknown coverage and the locations of the mobile stations becomes the major challenge in the development of the communication technology.

### SUMMARY OF THE INVENTION

The invention provides a method for adapting a modulation and coding scheme capable of improving the whole spectral efficiency of a multicast-and-broadcast service.

The invention provides a system for adapting a modulation and coding scheme which can dynamically change a modulation and coding scheme of a multicast-and-broadcast service according to the coverage corresponding to the multicast-and-broadcast service.

The invention provides a method for dynamically adapting a modulation and coding scheme for a base station transmitting a multicast-and-broadcast service to a plurality of subscribers in a covering range of the base station. The method comprises steps of the base station periodically performing a transmission adapting process in a service transmission duration of the multicast-and-broadcast service. The transmission adapting process comprises steps of the base station setting a feedback condition according to a coverage corresponding to the multicast-and-broadcast service. The base station sends a negative-acknowledge (NACK)-based feedback query to the subscribers, wherein the NACK-based feedback query includes the feedback condition, a feedback channel and feedback information corresponding to the multicast-and-broadcast service. For each of the subscribers, when a signal receiving condition of the subscriber does not satisfy the feedback condition, the subscriber transmits a NACK-based feedback to the base station through the feedback channel according to the feedback information. For each of the subscribers, when the signal receiving condition of the subscriber satisfies the feedback condition, the subscriber remains in a non-feedback status. According to a feedback-receiving status, the base station adapts a modulation and coding scheme for transmitting the multicast-and-broadcast service.

In one embodiment of the present invention, the step of setting the feedback condition comprises steps of, according to the coverage and a cell radius of the base station, the base station calculating a fixed signal-to-inference-plus-noise ratio corresponding to the coverage as the feedback condition.

In one embodiment of the present invention, the step of setting the feedback condition comprises steps of, before the base station periodically performs the transmission adapting process, the base station calculating a signal-to-inference-plus-noise ratio corresponding to the coverage according to the coverage and a cell radius of the base station. In a process cycle of each transmission adapting process periodically performed by the base station, the base station records the feedback-receiving status, wherein the base station records whether the NACK-based feedback is received or not in each process cycle. When the feedback-receiving status shows that the base station receives the NACK-based feedback in at least one process cycle, the base station upgrades the signal-to-inference-plus-noise ratio as the feedback condition. When the feedback-receiving status shows that the base station does not receive any NACK-based feedback in at least one process cycle, the base station degrades the signal-to-inference-plus-noise ratio as the feedback condition.

In one embodiment of the present invention, the base station sets the feedback condition by regarding the coverage as a signal correctness ratio of a signal received by each of the subscribers at a feedback time.

In one embodiment of the present invention, the NACK-based feedback is in a form of a code division multiple access code.

The invention provides a system for dynamically adapting a modulation and coding scheme for a base station transmitting a multicast-and-broadcast service to a plurality of subscribers in a covering range of the base station. The system comprises a transceiver and a processor. The transceiver is configured in the base station. The processor is configured in the base station for transmitting the multicast-and-broadcast service through the transceiver and executing a computer readable-and-writable program to periodically perform a transmission adapting process in a service transmission duration of the multicast-and-broadcast service. The transmission adapting process includes steps of the base station setting a feedback condition according to a coverage corresponding to the multicast-and-broadcast service. The base station sends a negative-acknowledge (NACK)-based feedback query to the subscribers, wherein the NACK-based feedback query includes the feedback condition, a feedback channel and feedback information corresponding to the multicast-and-broadcast service. Through the transceiver, the feedback channel for receiving a NACK-based feedback from the subscribers is monitored to obtain a feedback-receiving status. According to the feedback-receiving status, a modulation and coding scheme is adapted for transmitting the multicast-and-broadcast service.

In one embodiment of the present invention, the processor executing the computer readable-and-writable program to set the feedback condition comprises the step of, according to the coverage and a cell radius of the base station, the base station calculating a fixed signal-to-inference-plus-noise ratio corresponding to the coverage as the feedback condition.

In one embodiment of the present invention, the processor executing the computer readable-and-writable program to set the feedback condition comprises steps of, before the base station periodically performs the transmission adapting process, the base station calculating a signal-to-inference-plus-noise ratio corresponding to the coverage according to the coverage and a cell radius of the base station. In a process cycle of each transmission adapting process periodically performed by the base station, the base station records the feedback-receiving status by the transceiver monitoring the feedback channel. When the feedback-receiving status shows that the base station receives the NACK-based feedback in at least one process cycle, the base station upgrades the signal-to-inference-plus-noise ratio as the feedback condition. When the feedback-receiving status shows that the base station does not receive any NACK-based feedback in at least one process cycle, the base station degrades the signal-to-inference-plus-noise ratio as the feedback condition.

In one embodiment of the present invention, the processor executes the computer readable-and-writable program to set the feedback condition by regarding the coverage as a signal correctness ratio of a signal received by each of the subscribers at a feedback time.

In one embodiment of the present invention, the NACK-based feedback is in a form of a code division multiple access code.

In the method and system of the present invention for dynamically adapting a modulation and coding scheme, according to the coverage which is set to ensure the service quality of the multicast-and-broadcast service, the feedback condition is set to be the fixed signal-to-interference-plus-noise ratio, the dynamically changed signal-to-interference-plus-noise ratio or the coverage regarded as the received signal correctness ratio. Moreover, the NACK-based feedback query is sent to the subscribers. Then, according to the feedback-receiving status, the modulation and coding scheme for transmitting the multicast-and-broadcast service is dynamically adapted. Thus, under the circumstance that the coverage target value is satisfied, the spectral efficiency is maximized.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a process flow diagram, schematically illustrating a method for dynamically adapting a modulation and coding scheme according to one embodiment of the invention.

FIG. 2 is a process flow showing the step of setting a feedback condition according to one embodiment of the present invention.

FIG. 3 is a process flow showing the step of setting a feedback condition according to another embodiment of the present invention.

FIG. 4 is a process flow showing the step of setting a feedback condition according to the other embodiment of the present invention.

FIG. 5A is a diagram showing an ideal distribution of received signal correctness versus time.

FIG. 5B is a diagram showing an actual distribution of received signal correctness versus time.

FIG. 6 is a schematic diagram showing a system for dynamically adapting a modulation and coding scheme according to one embodiment of the invention.

### DESCRIPTION OF THE PREFERRED EMBODIMENTS

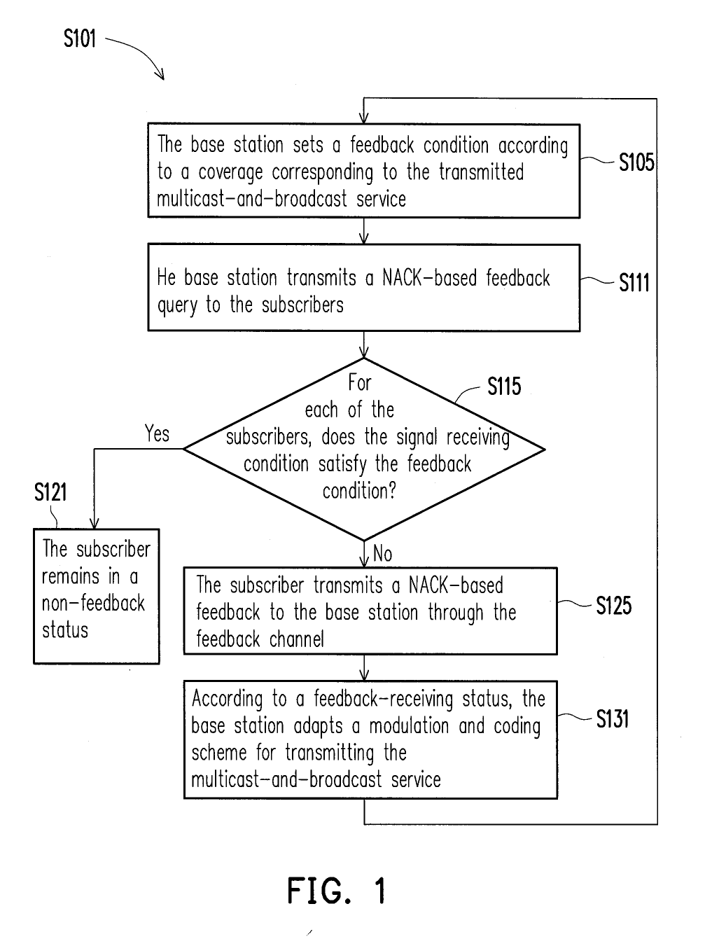

FIG. 1 is a process flow diagram, schematically illustrating a method for dynamically adapting a modulation and coding scheme according to one embodiment of the invention. The method of the present embodiment for adapting a modulation and coding scheme is suitable for a base station transmitting a multicast-and-broadcast service to a plurality of subscribers in a covering range of the base station. It should be noticed that the operation mode of each of the subscribers includes awake mode, sleep mode or idle mode.

As shown in FIG. 1, in the step S101, during the service transmission duration of the base station transmitting the multicast-and-broadcast service, the base station periodically performs a transmission adapting process.

In the present embodiment, in the time flow for transmitting the whole multicast-and-broadcast service, the time is divided into several radio frames with fixed time space. Each of the radio frames is further divided into an uplink portion and a downlink portion. The base station transmits the multicast-and-broadcast service to the subscribers in every several radio frames. Those radio frames are regarded as a multicast-and-broadcast service scheduling interval (MSI).

The aforementioned transmission adapting process is that the base station transmits the multicast-and-broadcast service and a negative acknowledge-based feedback query (NACK-based feedback query) to the subscribers through the downlink of one radio frame in the MSI. The subscribers receive the multicast-and-broadcast service and the NACK-based feedback query. Then, according to the feedback condition included in the NACK-based feedback query, when the signal receiving condition of the subscriber does not satisfy the feedback condition, the subscriber transmits a NACK-based feedback to the base station through the uplink of the radio frame. Further, the base station, according to the HACK-based feedback-receiving status, adapts the modulation and coding scheme (MCS) for transmitting the multicast-and-broadcast service. Moreover, the base station setting the feedback condition and sending the NACK-based feedback query to the subscriber to query about the signal receiving conditions can be done every several MSIs or can synchronize each single MSI. Those aforementioned MSIs are together regarded as a query interval (T_{query}). On the other words, the base station sets the feedback condition and reserved the feedback channel for the subscribers to transmit NACK-based feedback in every query interval.

More specifically, as shown in FIG. 1, the transmission adapting process comprises that, in the step S105, the base station sets a feedback condition according to a coverage corresponding to the transmitted multicast-and-broadcast service. The coverage is that, in the covering range of a single base station, the average block error rate of the packets or the signals of the broadcast service received by the subscribers located in the service quality guarantee range corresponding to the coverage must be smaller than the block error rate upper limit. For instance, in IEEE 802.16m standard, the performance of the multicast-and-broadcast service is evaluated by observing the maximum transmission rate while the block error rate of the packets received by the subscribers is smaller than 1% under the coverage of 95%. That is, the service quality is ensured within the coverage of 95%. It should be noticed that, the multicast-and-broadcast service can be classified into three types including streaming service, download service and carousel service. The streaming service is contiguous multimedia so that it is important to maintain the image playing smoothness. Thus, there is limitation in minimum data transmission rate. For instance, the data transmission rate of the streaming service is at least not less than 384 kbps (kilo-bits per second). The download service is the binary data transfer which does not have strict delay limitation but the reliability of the transmission is very important. For instance, the download service can be the conventional data transmission transmitting data to multiple mobile stations. The carousel service is a service combining the streaming service with the download service. The carousel service has static images needed to be synchronized and the contents of the static images are updated according to the repetitiveness of the environment. For instance, the carousel service can be the daily stock fluctuation or weather forecast displayed by the mobile phone. For different multicast-and-broadcast services, there are different limitations and requirements such as different service fee requirements from the service provider or different qualities of service (QoS). That is, different multicast-and-broadcast services respectively correspond to different coverages of the base station. For instance, as for the movie service with higher service fee, the requirement of the QoS is higher and the corresponding coverage is higher as well. As for the carousel service or advertisement service, the requirement of QoS is low and the coverage requirement is not strict since it is tolerable that the service can be occasionally interrupted.

Thereafter, in the step S111, the base station transmits a NACK-based feedback query to the subscribers in the covering range of the base station. The NACK-based feedback query comprises the set feedback condition, a feedback channel and feedback information corresponding to the multicast-and-broadcast service. The base station transmits the NACK-based feedback query to the subscribers through, for example, a multicast control channel (MCCH). Moreover, the feedback channel can be, for example, a dedicated control channel (DCCH), a shared channel (SCH) or a random access-based channel (RACH). For instance, the subscribers can share the random access-based channel no matter the operation mode of the subscribers is the awake mode, the sleep mode or the idle mode. Furthermore, in the present embodiment, in order to adapting the radio resource to decrease the command information right after the base station receives the feedback, it is not necessary to transmit the feedback from subscribers with the accurate information of the channel quality. Thus, NACK-based feedback is used as the feedback used by the subscribers. In the present embodiment, NACK-based feedback is in a form of the code division multiple access code (CDMA code).

In order to determine which one of the different multicast-and-broadcast services to be performed with the radio resource adapting process, different multicast-and-broadcast services use different CDMA codes as feedbacks. That is, the subscribers which subscribe the same multicast-and-broadcast service use the same CDMA code as the NACK-based feedback and transmit the NACK-based feedback to the base station. Moreover, when the subscribers which subscribe the same multicast-and-broadcast service and use the same CDMA code as the NACK-based feedback simultaneously transmit the NACK-based feedback to the base station, the feedback can be avoided from collision which leads to information loss.

Further, in the step S115, for each of the subscribers, whether the signal receiving condition satisfies the feedback condition included in the NACK-based feedback query is determined. When the signal receiving condition of the subscriber satisfies the feedback condition, the subscriber remains in a non-feedback status (or in a silent mode) (step S121). When a signal receiving condition of the subscriber does not satisfy the feedback condition, the subscriber transmits a NACK-based feedback to the base station through the feedback channel according to the feedback information (step S125). For instance, when the base station set the feedback condition is a first signal-to-interference-plus-noise ratio (SINR), the subscriber compares a second SINR of the current received multicast-and-broadcast service with the first SINR. When the second SINR is larger than the first SINR, which means the signal receiving condition of the subscriber satisfies the feedback condition, the subscriber does not transmits the NACK-based feedback to the base station (that is, the subscriber remains in a non-feedback status). On the contrary, when the second SINR is smaller than the first SINR, which means the signal receiving condition of the subscriber does not satisfy the feedback condition, the subscriber transmits the NACK-based feedback to the base station through the reserved feedback channel.

In the step S131, according to a feedback-receiving status, the base station adapts a modulation and coding scheme for transmitting the multicast-and-broadcast service.

In the aforementioned embodiment, the feedback condition is set by the base station according to the coverage corresponding to the multicast-and-broadcast service transmitted by the base station. The exemplars of setting the feedback condition by the base stations are described in the followings.

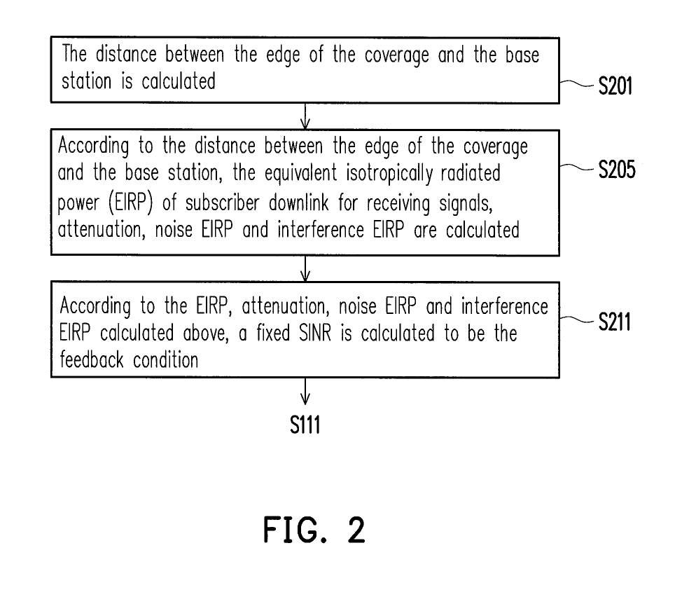

FIG. 2 is a process flow showing the step of setting a feedback condition according to one embodiment of the present invention. As shown in FIG. 2, according to the coverage and a cell radius of the base station, the base station calculates a fixed SINR corresponding to the coverage as the feedback condition. In the step S201, the distance (x) between the edge of the coverage and the base station is calculated according to the coverage(c), the cell radius (r) and the equation (a) shown as following:

x=r√c (a)

Then, in the step S205, according to the distance (x) between the edge of the coverage and the base station, the equivalent isotropically radiated power (EIRP) of subscriber downlink for receiving signals, attenuation R(x), noise EIRP (N) and interference EIRP (I) are calculated. Thereafter, in the step S211, according to the EIRP, attenuation R(x), noise EIRP (N) and interference EIRP (I) calculated above, a fixed SINR (SINR_{low} as known as the lower limit of the feedback condition) is calculated with the use of the equation (b) shown as following:

$${SINR}_{low} = 10 \times {log}_{10} [ \frac{{10}^{\frac{R ( x )}{10}}}{{10}^{\frac{N}{10 }} + {10}^{\frac{I}{10}}} ] = R ( x ) - 10 {log}_{10} ( {10}^{\frac{N}{10}} + {10}^{\frac{I}{10}} ) \qquad ( b )$$

By using the fixed SINR as the feedback condition, when the SINR of the multicast-and-broadcast service received by the subscriber is smaller than the SINR corresponding to the modulation and coding scheme currently used by the base station and larger than the fixed SINR, the subscriber transmits the NACK-based feedback to the base station. On the contrary, the subscriber remains in the non-feedback status.

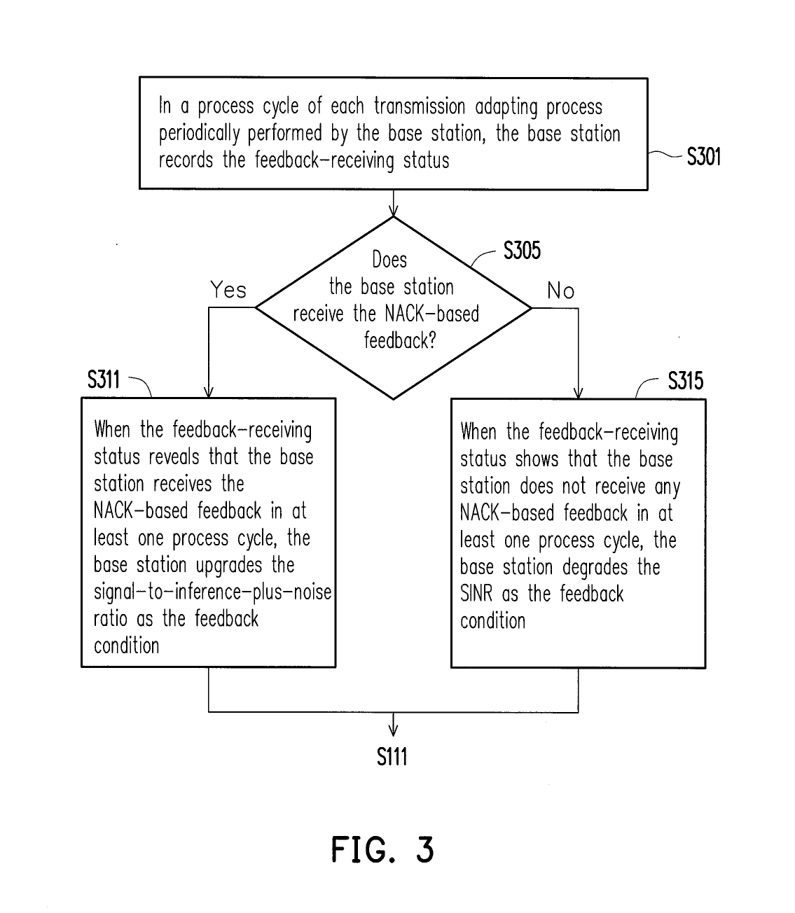

FIG. 3 is a process flow showing the step of setting a feedback condition according to another embodiment of the present invention. As shown in FIG. 3, before the base station periodically performs the transmission adapting process, the base station calculates a SINR corresponding to the coverage according to the coverage and the cell radius of the base station. The aforementioned step for calculating a SINR corresponding to the coverage according to the coverage and the cell radius is as same as the method mentioned in the previous embodiment (as shown in steps S201˜S211) and is not described herein. In the step S301, in a process cycle of each transmission adapting process periodically performed by the base station, the base station records the feedback-receiving status. More clearly, the base station records whether the NACK-based feedback is received or not in each process cycle. In the step S305, whether the base station receives the NACK-based feedback is determined.

According to the feedback-receiving status, the lower limit of the SINR is dynamically changed. That is, in the step S311, when the feedback-receiving status reveals that the base station receives the NACK-based feedback in at least one process cycle, the base station upgrades the signal-to-inference-plus-noise ratio as the feedback condition. For instance, when the base station receives NACK-based feedbacks in both of two consecutive process cycles, it is possible that the lower limit of the SINR is too small. Thus, the base station upgrades the SINR to avoid receiving NACK-based feedback. In the step S315, when the feedback-receiving status shows that the base station does not receive any NACK-based feedback in at least one process cycle, the base station degrades the SINR as the feedback condition. For instance, when the base station does not receive NACK-based feedbacks in both of two consecutive process cycles, it is possible that the lower limit of the SINR is too high. Thus, the base station degrades the SINR to avoid neglecting the signal quality of most of the subscribers. When the feedback-receiving status reveals that the situations of base station receiving and not receiving NACK-based feedbacks in two consecutive process cycles do not happen, the original SINR for the base station transmitting the multicast-and-broadcast service remains unchanged (not shown). In the present embodiment, the feedback condition is set according to whether the base station receives the NACK-based feedbacks in both of two consecutive process cycles. However, the present invention is not limited to the aforementioned scenarios. That is, in the other embodiments with different practical requirements, the feedback condition can be set in accordance with whether the base station receives the NACK-based feedback in each of the process cycles, whether the base station receives the NACK-based feedbacks respectively in more than one consecutive process cycles or whether the base station receives the NACK-based feedbacks respectively in every other or some other process cycles.

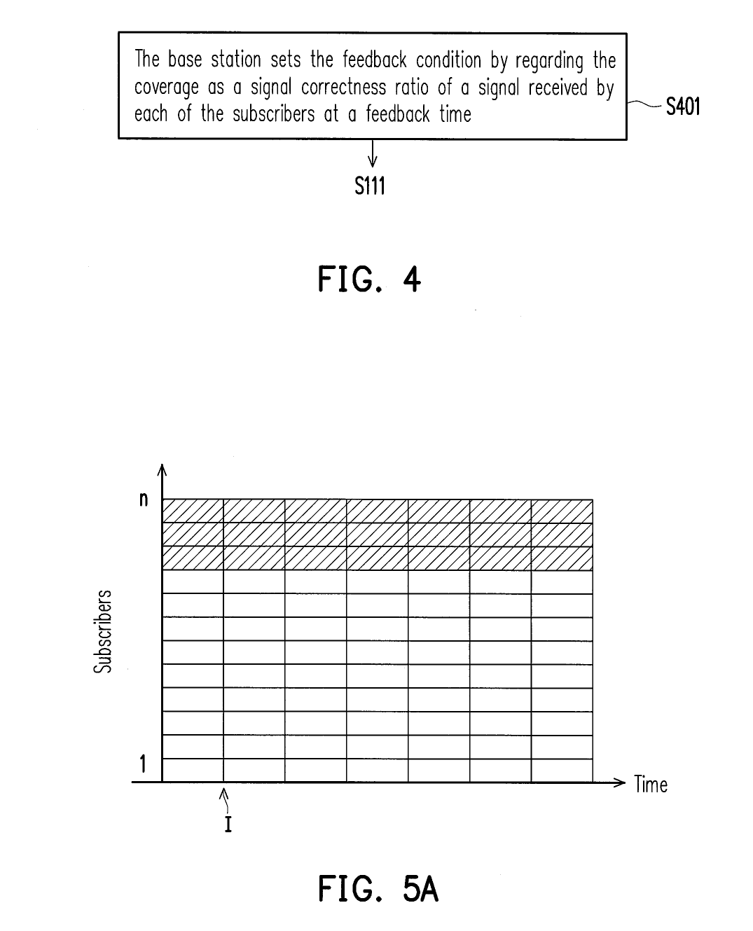

FIG. 4 is a process flow showing the step of setting a feedback condition according to the other embodiment of the present invention. As shown in FIG. 4, in the step S401, the base station sets the feedback condition by regarding the coverage as a signal correctness ratio of a signal received by each of the subscribers at a feedback time.

More specifically, the coverage is the area ratio of the area of the partial covering range with service quality guarantee to the area of the whole covering range of the base station. Hence, when the subscribers are uniformly distributed in the whole coverage of the base station (which is the cell range of the base station), with the increasing of the number of the subscribers, the subscribers can be classified into a group of subscribers who are within the partial covering range with service quality guarantee and another group of subscribers who are at the outside of the partial covering range with service quality guarantee. At this time, the coverage can be regarded as the ratio of the number of the subscribers in the partial covering range with service quality guarantee to the number of the whole subscribers in the whole covering range. On the other words, the subscribers within the partial covering range with the service quality guarantee are the subscribers satisfied with the limited coverage. Thus, the coverage can be regarded as the ratio of the number of the subscribers with the service quality satisfaction to the total number of the whole subscribers.

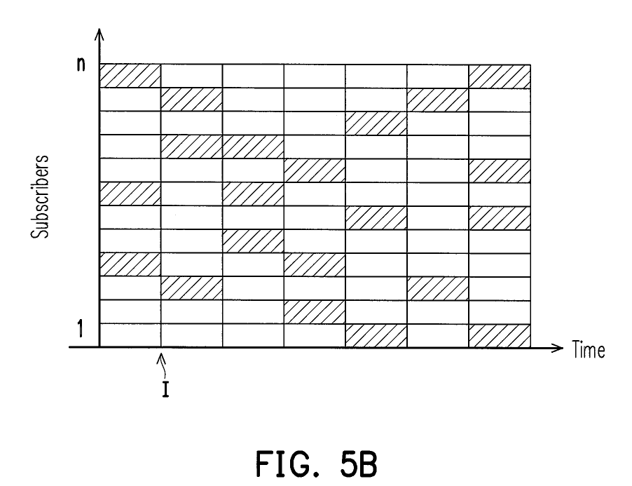

As shown in FIG. 5A, each lattice represents whether, at the time I (such as the MSI), the multicast-and-broadcast service received by a subscriber is correct, wherein the lattice filled with oblique lines represents signal incorrectness and the blank lattice represents signal correctness. Theoretically, in each time I, the signal correctness ratio of the service received by the whole subscribers is equal to the coverage. That is, the signal receiving status of the subscribers within the partial covering rang with service quality guarantee is normal. However, in practice, at the time I, the signal correctness ratio of the number of the correct signals which have been received by each of the subscribers to the total number of signals which have been received by each of the subscribers may not exactly equal to the coverage. As shown in FIG. 5B, at the time I (such as the first MSI), the signal correctness ratio of the service received by each of the subscribers is fluctuated around the coverage. Hence, as long as the signal correctness ratio of the service received by each of the subscribers maintains close to the coverage, the signal correctness ratio of the whole service for the whole transmission duration of the multicast-and-broadcast service closely approximates to the theoretical situation. That is, the signal correctness ratio is equal to the coverage.

On the other words, the feedback condition is set by regarding the coverage as the signal correctness ratio of the service which have been received by one subscriber at a feedback time. Therefore, for each of the subscribers, when the SINR of the multicast-and-broadcast service received by the subscriber is smaller than the lower limit of the SINR corresponding to the modulation and coding scheme of the base station transmitting the multicast-and-broadcast service and the signal correctness ratio of the service received by the subscriber is smaller than the coverage, the signal receiving condition of the subscriber does not satisfy the feedback condition. Accordingly, the subscriber transmits a NACK-based feedback to the base station through the feedback channel.

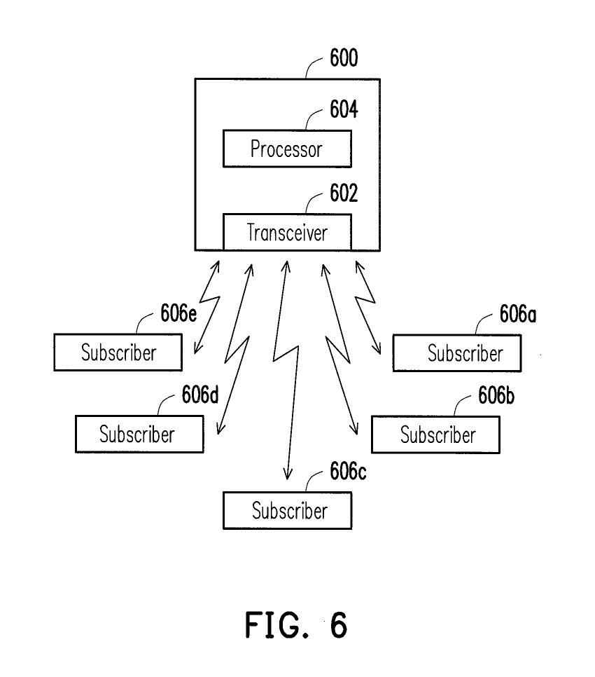

FIG. 6 is a schematic diagram showing a system for dynamically adapting a modulation and coding scheme according to one embodiment of the invention. As shown in FIG. 6, in the present invention, the aforementioned method for dynamically adapting the modulation and coding scheme can be implemented by a system 600. The system 600 can be, for example, a base station. The system 600 comprises a transceiver 602 and a processor 604 which are configured in the system 600 (or the base station). The processor 604 transmits the multicast-and-broadcast service through the transceiver 602 and executes a computer readable-and-writable program to periodically perform a transmission adapting process in the service transmission duration of the multicast-and-broadcast service (as shown in the step S101 of FIG. 1). Moreover, the steps of the transmission adapting process performed by the processor 604 executing the computer readable-and-writable program comprises setting a feedback condition according to a coverage corresponding to the multicast-and-broadcast service (as shown in the step S105 of FIG. 1). The transceiver 602 transmits a NACK-based feedback query (such as through a multicast control channel) to the subscribers (including subscribers 606a, 606b, 606c, 606d and 606e). The NACK-based feedback query includes the feedback condition, a feedback channel and feedback information corresponding to the multicast-and-broadcast service (as shown in the step S111 of FIG. 1). Through the transceiver 602, a feedback-receiving status is obtained by monitoring the feedback channel for receiving a NACK-based feedback from the subscribers (as shown in the step S125 of FIG. 1). According to the feedback-receiving status, the modulation and coding scheme for transmitting the multicast-and-broadcast service is adapted (as shown in the step S131 of FIG. 1).

Moreover, the processor 604 executing the computer readable-and-writable program to set the feedback condition includes steps of calculating a fixed signal-to-inference-plus-noise ratio corresponding to the coverage as the feedback condition according to the coverage and a cell radius of the base station (as shown in the steps S201 through S211 of FIG. 2); adjusting the lower limit of the SINR according to whether the base station receives the NACK-based feedback (such as whether the base station receives the NACK-based feedback respectively in two consecutive process cycles) (as shown in the steps S301 through S315 of FIG. 3); setting the feedback condition by regarding the coverage as the signal correctness ratio of the signal received by each of the subscribers at a feedback time (as shown in the step S401 of FIG. 4).

In the method and system of the present invention for dynamically adapting the modulation and coding scheme, the feedback condition is set to be the fixed SINR, the dynamically changed SINR or the coverage regarded as the received signal correctness ratio according to the coverage which is set to ensure the service quality of the multicast-and-broadcast service. The feedback condition is included in the NACK-based feedback query and is transmitted to the subscribers. According to the feedback-receiving status, the modulation and coding scheme for transmitting the multicast-and-broadcast service is dynamically adapted. Thus, under the circumstance that the coverage target value is satisfied, the spectral efficiency is maximized.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for dynamically adapting a modulation and coding scheme for a base station transmitting a multicast-and-broadcast service to a plurality of subscribers in a covering range of the base station, the method comprising:
the base station periodically performing a transmission adapting process in a service transmission duration of the multicast-and-broadcast service, wherein the transmission adapting process includes:
the base station setting a feedback condition according to a coverage corresponding to the multicast-and-broadcast service;
the base station sending a negative-acknowledge (NACK)-based feedback query to the subscribers, wherein the NACK-based feedback query includes the feedback condition, a feedback channel and feedback information corresponding to the multicast-and-broadcast service;
for each of the subscribers, when a signal receiving condition of the subscriber does not satisfy the feedback condition, the subscriber transmitting a NACK-based feedback to the base station through the feedback channel according to the feedback information;
for each of the subscribers, when the signal receiving condition of the subscriber satisfies the feedback condition, the subscriber remaining in a non-feedback status; and
according to a feedback-receiving status, the base station adapting a modulation and coding scheme for transmitting the multicast-and-broadcast service.

2. The method of claim 1, wherein the step of setting the feedback condition comprises:
according to the coverage and a cell radius of the base station, the base station calculating a fixed signal-to-inference-plus-noise ratio corresponding to the coverage as the feedback condition.

3. The method of claim 1, wherein the step of setting the feedback condition comprises:
before the base station periodically performs the transmission adapting process, the base station calculating a signal-to-inference-plus-noise ratio corresponding to the coverage according to the coverage and a cell radius of the base station;
in a process cycle of each transmission adapting process periodically performed by the base station, the base station recording the feedback-receiving status, wherein the base station records whether the NACK-based feedback is received or not in each process cycle;
when the feedback-receiving status shows that the base station receives the NACK-based feedback in at least one process cycle, the base station upgrading the signal-to-inference-plus-noise ratio as the feedback condition; and
when the feedback-receiving status shows that the base station does not receive any NACK-based feedback in at least one process cycle, the base station degrading the signal-to-inference-plus-noise ratio as the feedback condition.

4. The method of claim 1, wherein the base station sets the feedback condition by regarding the coverage as a signal correctness ratio of a signal received by each of the subscribers at a feedback time.

5. The method of claim 1, wherein the NACK-based feedback is in a form of a code division multiple access code.

6. A system for dynamically adapting a modulation and coding scheme for a base station transmitting a multicast-and-broadcast service to a plurality of subscribers in a covering range of the base station, the system comprising:
a transceiver configured in the base station;
a processor configured in the base station for transmitting the multicast-and-broadcast service through the transceiver and executing a computer readable-and-writable program to periodically perform a transmission adapting process in a service transmission duration of the multicast-and-broadcast service, wherein the transmission adapting process includes:
the base station setting a feedback condition according to a coverage corresponding to the multicast-and-broadcast service;
the base station sending a negative-acknowledge (NACK)-based feedback query to the subscribers, wherein the NACK-based feedback query includes the feedback condition, a feedback channel and feedback information corresponding to the multicast-and-broadcast service;
obtaining a feedback-receiving status by monitoring the feedback channel for receiving a NACK-based feedback from the subscribers through the transceiver; and
according to the feedback-receiving status, adapting a modulation and coding scheme for transmitting the multicast-and-broadcast service.

7. The system of claim 6, wherein the processor executing the computer readable-and-writable program to set the feedback condition comprises:
according to the coverage and a cell radius of the base station, the base station calculating a fixed signal-to-inference-plus-noise ratio corresponding to the coverage as the feedback condition.

8. The system of claim 6, wherein the processor executing the computer readable-and-writable program to set the feedback condition comprises:
before the base station periodically performs the transmission adapting process, the base station calculating a signal-to-inference-plus-noise ratio corresponding to the coverage according to the coverage and a cell radius of the base station;
in a process cycle of each transmission adapting process periodically performed by the base station, the base station recording the feedback-receiving status by the transceiver monitoring the feedback channel;
when the feedback-receiving status shows that the base station receives the NACK-based feedback in at least one process cycle, the base station upgrading the signal-to-inference-plus-noise ratio as the feedback condition; and
when the feedback-receiving status shows that the base station does not receive any NACK-based feedback in at least one process cycle, the base station degrading the signal-to-inference-plus-noise ratio as the feedback condition.

9. The system of claim 6, wherein the processor executes the computer readable-and-writable program to set the feedback condition by regarding the coverage as a signal correctness ratio of a signal received by each of the subscribers at a feedback time.

10. The system of claim 6, wherein the NACK-based feedback is in a form of a code division multiple access code.
